(19) United States
(12) Patent Application Publication
(10) Pub. No.: US 2024/0101364 A1
(43) Pub. Date: Mar. 28, 2024

(54) FEEDER UNIT FOR DIRECT, LOW LEAKAGE ATTACHMENT TO DRY MATERIAL BUCKET

(71) Applicant: USC, LLC, Sabetha, KS (US)

(72) Inventors: James Renyer, Sabetha, KS (US); Austin Wasinger, Sabetha, KS (US)

(73) Assignee: USC, LLC, Sabetha, KS (US)

(21) Appl. No.: 17/934,320

(22) Filed: Sep. 22, 2022

Related U.S. Application Data
(60) Provisional application No. 63/247,149, filed on Sep. 22, 2021.

(51) Int. Cl. B65G 65/32; B65G 33/14; B65G 33/24

(52) U.S. Cl. CPC B65G 65/32; B65G 33/14; B65G 33/24; B65G 2201/04

(57) ABSTRACT

A feeder assembly includes a feeder unit and an open top portable storage vessel defining an interior chamber. The feeder unit includes a feeder and a coupler securing the feeder to the vessel. The feeder defines a feed opening in communication with the interior chamber. The feeder includes a conveyance assembly in communication with the feed opening. The coupler is selectively secured to the feeder and independently selectively secured to the vessel, such that the coupler selectively secures the feeder to the vessel. The feeder unit facilitates dispensation of a material from the vessel. The method includes the steps of securing the vessel to the feeder, such that the feed opening is in communication with the interior chamber through the open top; collectively inverting the vessel and the feeder; and operating the feeder such that material from the vessel is dispensed by the feeder.

### CROSS-REFERENCE TO RELATED APPLICATION

### 1. Priority Application

The present application claims the benefit of and priority from U.S. Provisional Patent Application No. 63/247,149, filed Sep. 22, 2021, the entire disclosure of which is hereby incorporated by reference herein.

### BACKGROUND OF THE INVENTION

### 1. Field of the Invention

The present invention relates generally to structure and methodology for controlled extraction of material (most preferably dry material) from a portable storage vessel and subsequent controlled dispensation of the material to a target location. In an illustrated embodiment of the present invention, for instance, a portable feeder unit is attached to a portable storage vessel containing a material and is operable to extract and dispense the material therefrom in a controlled manner. The portable feeder unit can then be removed from the portable storage vessel for later use (e.g., via attachment to another portable storage vessel).

### 2. Discussion of the Prior Art

Various methods of mixing or combining materials in a controlled manner are known in the art. For instance, in agricultural applications such as seed treatment processes, methods are well known by which seeds are coated or mixed with particulate or powder materials including but not limited to fungicides, insecticides, biologicals, nematicides, lubricants (such as talc), and/or other additives to enhance the performance of the seeds during storage, planting, and/or growing. Such methods conventionally require pouring of a desired material from an initial storage or supply container into a fixed hopper, followed by transfer of the material from the fixed hopper into a feeder unit permanently or semi-permanently fixed to the hopper. The material is then dispensed from the feeder unit into a target or recipient container upon operation of the feeder, which may contain an auger, paddles, or other means for shifting the material.

In such conventional methods, a given feeder unit is associated with only a single hopper; and the location at which the process is undertaken is limited by the location of the hopper. Furthermore, the need to pour or otherwise transfer the material from the initial storage or supply container to the hopper for subsequent dispensation by the feeder both exposes the material to potential contamination and enables contamination of the general environment by the material (e.g., via distribution of dust during the pouring process).

### SUMMARY

According to one aspect of the present invention, a feeder unit is provided. The feeder unit is for attachment to a portable storage vessel defining an interior chamber. The feeder unit comprises a feeder and a coupler. The feeder defines a feed opening in communication with the interior chamber when the feeder is secured to the portable storage vessel by the coupler. The feeder includes a conveyance assembly in communication with the feed opening. The coupler is configured to be selectively securable to the feeder and independently selectively securable to the portable storage vessel, such that the coupler is operable to selectively secure the feeder to the portable storage vessel.

According to another aspect of the present invention, a feeder assembly comprises a feeder unit and a portable storage vessel defining an interior chamber. The feeder unit includes a feeder and a coupler securing the feeder to the portable storage vessel. The feeder defines a feed opening in communication with the interior chamber. The feeder includes a conveyance assembly in communication with the feed opening. The coupler is selectively secured to the feeder and independently selectively secured to the portable storage vessel, such that the coupler selectively secures the feeder to the portable storage vessel.

According to yet another aspect of the present invention, a method of dispensing a material from an open top portable storage vessel is provided. The method comprises the steps of: (a) securing the portable storage vessel to a feeder, such that a feed opening of the feeder is in communication with an interior chamber of the portable storage vessel through the open top; (b) collectively inverting the portable storage vessel and the feeder; and (c) operating the feeder such that material from the portable storage vessel is dispensed by the feeder.

Among other things, use of a feeder assembly including a feeder unit selectively securable to a portable storage vessel facilitates repeated use of the feeder unit with various portable storage vessels. That is, the feeder unit may be used interchangeably with (i.e., selectively secured to and removed from) multiple portable storage vessels. The use of a portable storage vessel (i.e., instead of a fixed hopper, tank, or other structure) facilitates, among other things, use of the feeder unit in any desirable location without the need for specialized infrastructure and/or equipment. Furthermore, direct connection of the feeder unit to the portable storage vessel eliminates any intermediate pouring or transfer steps, as from an initial supply container into a hopper or similar structure, leading to decreased contamination risk for the material being dispensed and decreased risk of environmental contamination therefrom.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a top front perspective view of a portable feeder assembly and mounting assembly in accordance with a preferred embodiment of the present invention, wherein the feeder assembly includes a feeder unit and a portable supply vessel;

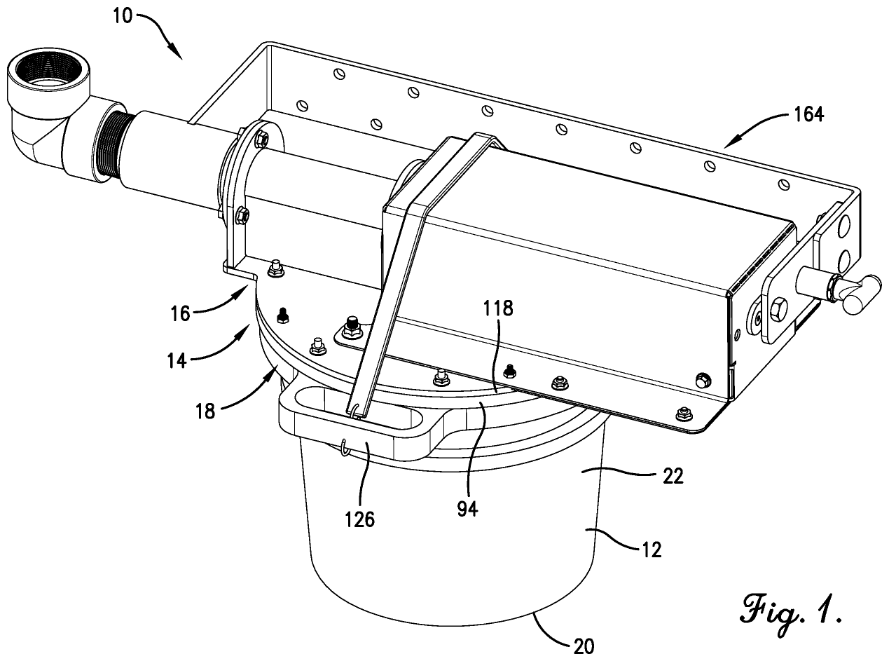

FIG. 2 is a bottom rear perspective view of the feeder assembly and mounting assembly of FIG. 1;

FIG. 3 is an exploded top front perspective view of the feeder assembly and mounting assembly of FIGS. 1 and 2;

FIG. 4 is an enlarged top perspective view of the feeder of the feeder unit of FIGS. 1-3, with the connector housing removed to illustrate internal components of the feeder, as well as of the mounting assembly;

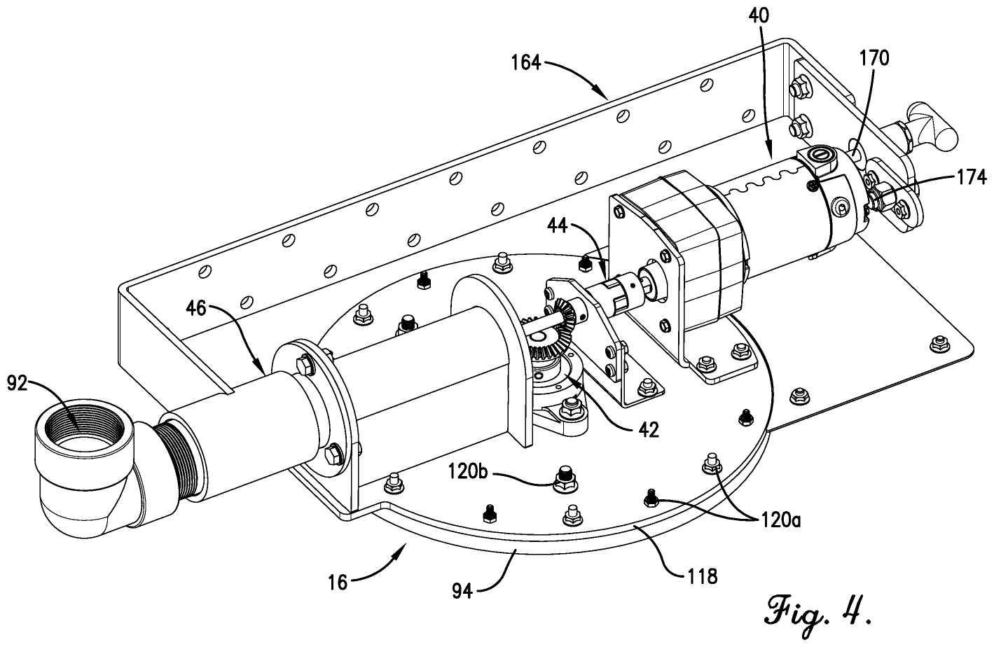

FIG. 5 is a bottom perspective view of the feeder and mounting assembly of FIG. 4;

FIG. 6 is an enlarged cross-sectional perspective view of a portion of the feeder assembly and mounting assembly of FIGS. 1-3;

FIG. 7 is a cross-sectional side view of the portion of the feeder assembly and mounting assembly of FIG. 6;

FIG. 8 is a cross-sectional perspective view of the portion of the feeder assembly and mounting assembly of FIGS. 6 and 7, taken orthogonally relative to that of FIGS. 6 and 7;

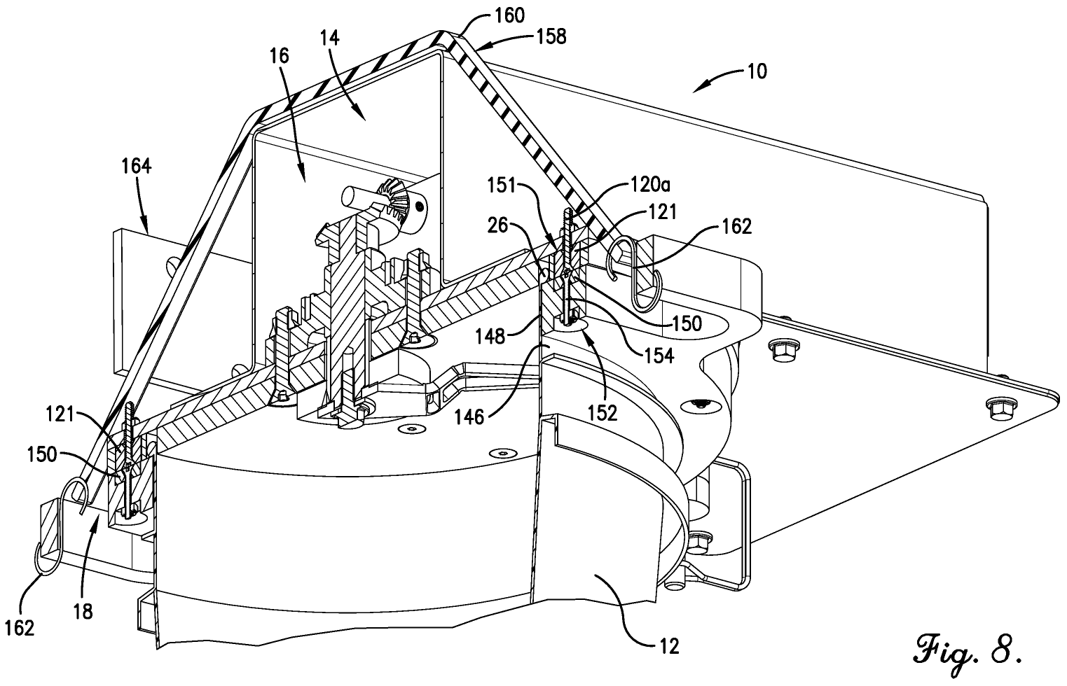

FIG. 9 is an enlarged, exploded top perspective view of the supply vessel and coupler of the feeder assembly of FIGS. 1-3 and 6-8, with the coupler in an open configuration;

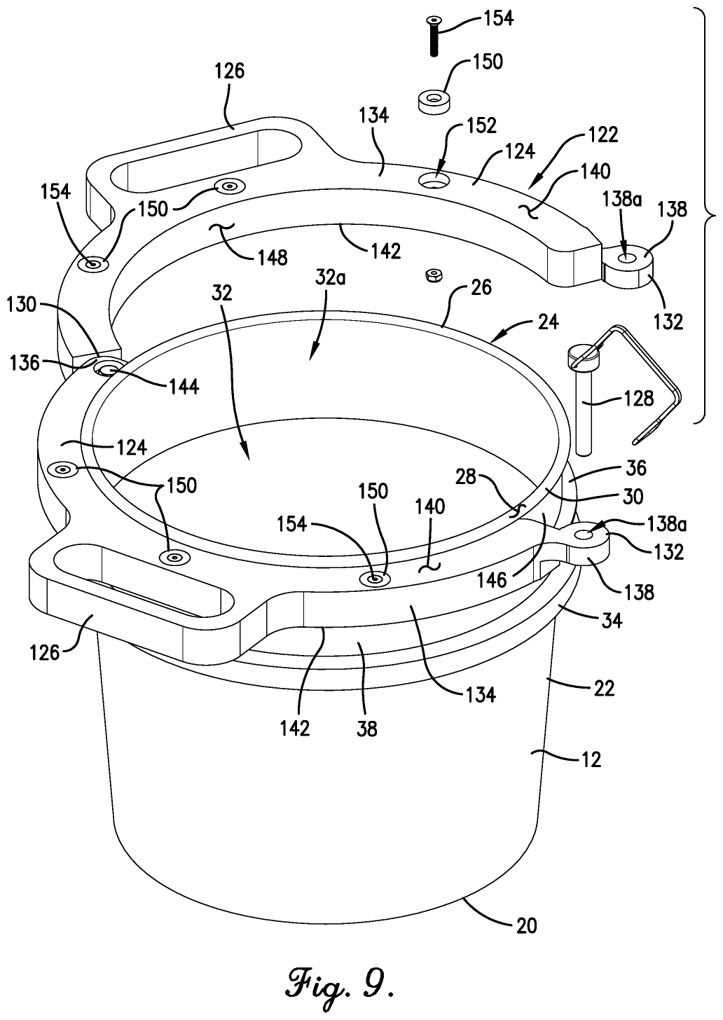

FIG. 10 is a top perspective view of the coupler of FIG. 9 and others in a closed configuration; and

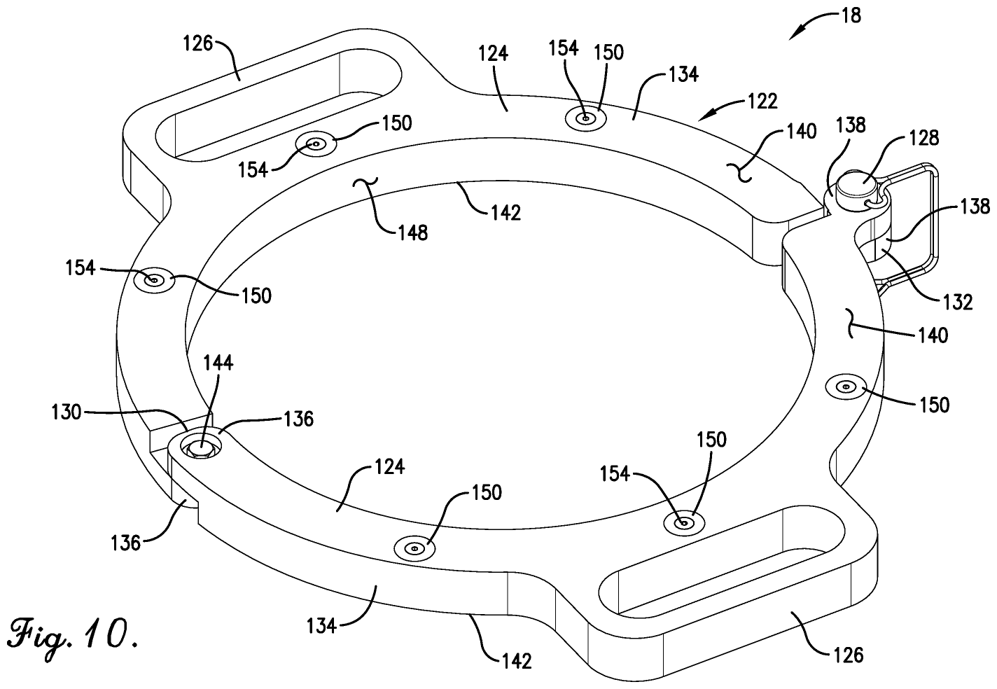

FIG. 11 is a bottom perspective view of the coupler of FIG. 10.

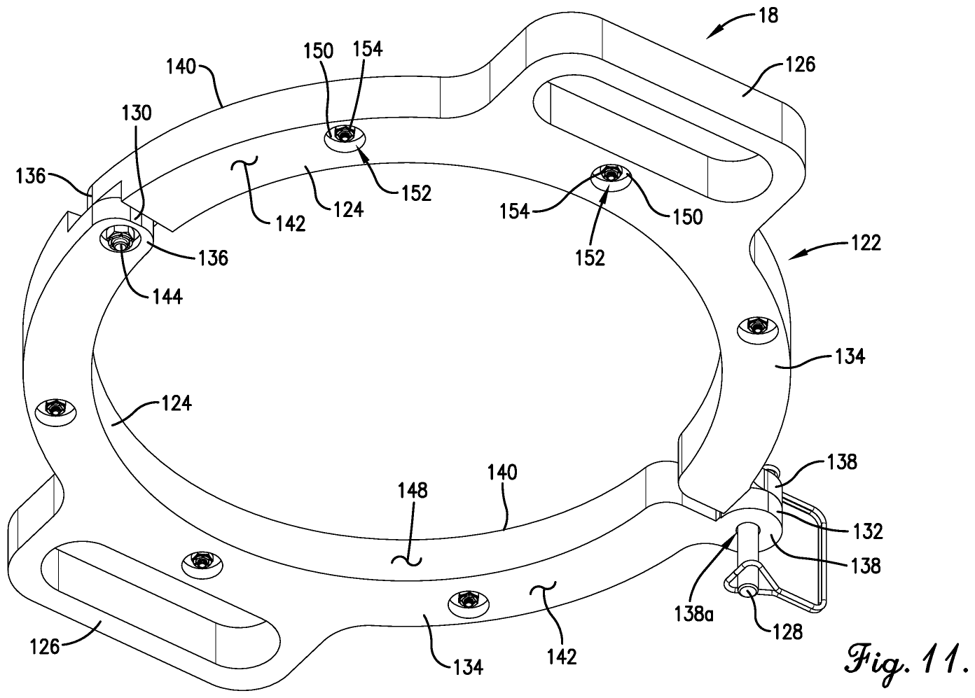

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

Furthermore, unless specified or made clear, the directional references made herein with regard to the present invention and/or associated components (e.g., top, bottom, upper, lower, inner, outer, etc.) are used solely for the sake of convenience and should be understood only in relation to each other. For instance, a component might in practice be oriented such that faces referred to as “top” and “bottom” are sideways, angled, inverted, etc. relative to the chosen frame of reference.

### Overview

According to a first preferred embodiment of the present invention, a feeder assembly 10 includes a portable storage vessel 12 and a portable feeder unit 14 selectively (i.e., removably) secured thereto. The portable feeder unit 14 preferably includes a feeder 16 and a coupler 18. As will be discussed in greater detail below, the coupler 18 selectively securely connects the feeder 16 to the vessel 12 to facilitate direct extraction of material (most preferably dry particulate or powdered material) from the vessel 12 and subsequent controlled (e.g., metered) transfer of the material through the feeder 16 to a predetermined location.

### Storage, Shipping, or Supply Vessel, Container, or Bucket

In the illustrated embodiment, the storage vessel 12, which may alternatively be described as a storage, shipping, or supply vessel, container, or bucket, preferably includes a base 20, a circumferentially continuously extending side 22 extending axially from the base 20 to present an end 24 opposite the base 20, and a circumferentially continuously extending rim 26 extending radially outwardly from the end 24. The rim 26 preferably presents upper and lower surfaces 28 and 30, respectively.

The base 20 and the side 22 cooperatively define an interior chamber 32 and an open top 32a of the vessel 12 (or, alternatively, of the interior chamber 32). The interior chamber 32 is configured to contain a material (not shown). In the illustrated embodiment, the feeder assembly 10 (and the interior chamber 32) is configured for use with one or more dry particulate or powder materials such as talc or other lubricants (e.g., graphite), micronutrients, inoculants, fungicides, insecticides, biologicals, nematicides, or other additives or combinations thereof as might be applied to seeds to improve flowability, reduce bridging, accelerate drying, resist infection, enhance growth, etc. Other applications and material types fall within the scope of some aspects of the present invention, however.

The vessel 12 preferably is configured to store between about one pound (1 lb) and about fifty pounds (50 lb), more preferably between about ten pounds (10 lb) and about thirty-five pounds (35 lb), and most preferably about twenty-five pounds (25 lb) of dry material in the interior chamber 32, although other vessel capacities are permissible without departing from the scope of certain aspects of the present invention.

Alternatively described, the vessel interior chamber 32 preferably has a capacity between about one gallon (1 gal) and about ten gallons (10 gal), and more preferably between about three gallons (3 gal) and about five gallons (5 gal).

It is noted that the vessel 12 may at times include a lid (not shown) or other covering. However, as will be apparent from further discussion below, full removal or shifting of any lid or covering to expose the open top 32a and, in turn, the interior chamber 32 is preferred for operation of the feeder assembly 10. It is permissible according to some aspects of the present invention, though, for the top of the vessel (or, alternatively, the top of the interior chamber) to be in part obstructed, if a sufficient opening exists for interconnection with the feeder. For instance, operation may in some instances be feasible with a lid in place, if the lid includes a functionally appropriate opening therethrough.

The base 20 and the rim 26 are preferably at least substantially round or circular and the side 22 is preferably at least substantially cylindrical. The base 20, the rim 26, and the side 22 also preferably share a common axis. The vessel 12 in a broad sense may thus be referred to as being generally cylindrical in shape or, in common terminology, as being a round bucket.

In the illustrated embodiment, the rim 26 presents a diameter that is slightly larger than that of the base 20, such that at least a portion of the side 22 flares outward from the base 20 to the rim 26. The vessel 12 in a broad sense thus is generally more specifically in the form of a flared cylinder or, in alternative language, is generally frustoconical in form.

The illustrated vessel 12 additionally includes a lower band 34 extending from and encircling the side 22 and disposed axially between the base 20 and the rim 26. The vessel 12 preferably further includes an intermediate projection 36 spaced axially from the rim and extending from and encircling the side 22. The intermediate projection 36 is most preferably disposed axially between the lower band 34 and the rim 26.

In a preferred embodiment, a straight portion 38 of the side 22 is defined axially between the lower band 34 and the rim 26. More particularly, the straight portion 38 extends axially (i.e., without tapering or flaring) such that a constant-diameter region of the vessel 12 is defined between the lower band 34 and the rim 26.

The vessel 12 as illustrated is of a conventional type well known to those of ordinary skill in the art. More particularly, the vessel 12 will be readily recognizable to those of ordinary skill in the art as a standard bucket as commonly utilized by manufacturers of dry goods and other substances and as readily available in home improvement and agricultural stores, among others. Such buckets are readily available in standardized sizes, including but not limited to three (3) and five (5) gallon configurations, both of which are particularly well suited for use as vessels of the present invention.

It is particularly noted that, while some specialized vessel varieties may be well suited for use with the present invention, specialized vessels are not inherently required. Furthermore, as will be discussed in greater detail below, numerous modifications to the illustrated vessel 12 might be made without affecting or disabling some aspects of its functionality as part of the feeder assembly 10. The band and/or projection might be omitted or alternatively positioned, for instance, the rim and/or side might include openings or other discontinuities, etc. If accompanied by corresponding modifications to the portable feeder unit 14, the general shape of the vessel (e.g., square in cross-section rather than circular, etc.) might be altered as well. The suitability or impropriety of any such modifications will be readily apparent to those of ordinary skill in the art based on discussions below of the remaining components of the feeder assembly 10.

In general, however, the compatibility of the feeder unit 14 with a conventional bucket 12 of the sort commonly used by manufacturers of dry material is a highly advantageous feature of the present invention.

### Feeder

The feeder 16 may be of any type known in the art that is suitable for extraction and conveyance of the material stored in the vessel 12. In the illustrated embodiment, the feeder 16 broadly includes a motor assembly 40, an extractor assembly 42, a connecting assembly 44, a conveyance assembly 46, and an attachment assembly 48.

The motor assembly 40 includes a motor (not shown) and a motor housing 50 at least substantially enclosing the motor in a motor compartment 52. The motor may be of any type know in the art, although it is most preferable that the motor be a variable speed motor to facilitate varying metering rates.

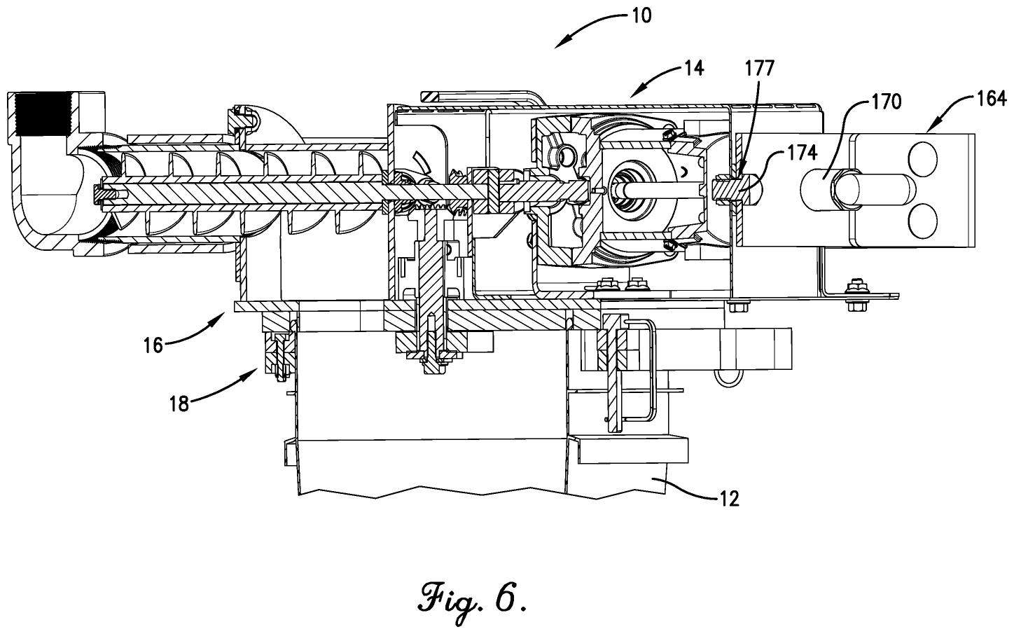

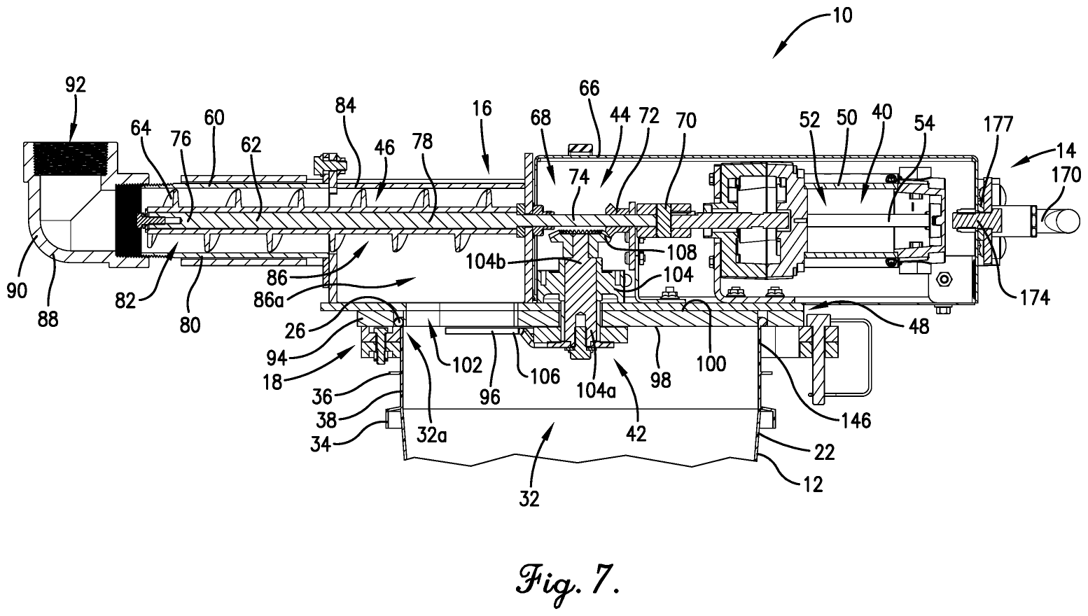

Preferably, the motor includes a motor output shaft 54 rotatable about a motor axis or an axis parallel thereto. A transmission shaft 56 preferably extends parallel to the motor output shaft 54 and is coupled therewith such that rotation of the output shaft 54 drives rotation of the transmission shaft 56 (see FIGS. 6 and 7).

The conveyance assembly 46 preferably includes an auger 58 and an auger housing 60 at least substantially enclosing the auger 58. The auger 58 includes a central shank 62 and a helical flighting 64 repeatedly encircling at least a portion of the central shank 62. Other auger designs fall within the scope of the present invention, however, as do entirely different types of conveyance assemblies.

The connecting assembly 44 preferably includes a connector housing 66 defining a connection chamber 68, a shaft coupler 70 disposed in the connection chamber 68, and a transmission gear 72 also disposed in the connection chamber 68. The shaft coupler 70 preferably connects the transmission shaft 56 to the shank 62 to transmit rotation from the transmission shaft 56 to the shank 62, such that rotation of the motor output shaft 54 is ultimately transferred to the auger 58.

The function of the transmission gear 72 will be discussed in greater detail below.

It is noted that, in the illustrated embodiment, the connector housing 66 additionally houses the motor (not shown) and the motor housing 50, although such enclosure is not required according to some aspects of the present invention.

The auger 58 generally includes an unflighted proximal portion 74 nearer to the motor, a flighted distal portion 76 further from the motor, and a flighted intermediate portion 78 disposed axially between the proximal and distal portions 76 and 78, respectively.

The auger housing 60 includes a barrel portion 80 defining a channel 82 through which the distal portion 76 of the auger 58 extends. Outer edges of the flighting 64 of the distal portion 76 of the auger 58 preferably touch or nearly touch the barrel portion 80 to eliminate or substantially eliminate the presence of radial gaps between the barrel portion 80 and the flighting 64. Such gaps would potentially have detrimental effects on material flow through uncontrolled transfer or leakage of material therethrough (e.g., if such gaps were relatively large compared to the dry material particles) or jamming of the auger 58 if particles were to become stuck therein (e.g., if such gaps were similar in size to the particulate).

The auger housing 60 also includes an intake portion 84 defining an intake chamber 86. The intermediate portion 78 of the auger 58 preferably extends through the intake chamber 86 in such a manner that an inflow portion 86a of the intake chamber 86 remains unobstructed. The inflow portion 86a will be discussed in greater detail below.

Still further, the auger housing 60 preferably includes an output portion 88. In the illustrated embodiment, the output portion 88 includes an elbow 90 and defines a terminal outlet opening 92. However, other shapes fall within the scope of the present invention. Most preferably, the output portion 88 is configured to direct flow of the dry material (or other material being dispensed) to a predetermined target location. For instance, the illustrated output portion 88 might direct the dry material to agricultural equipment such as a seed bin, seed hopper, seed feeder, mobile seeder, etc.

The attachment assembly 48 preferably includes a cover 94. The attachment-related features of the cover 94 will be discussed in greater detail below. In a broad sense, however, it is noted that the cover 94 cooperates with the coupler 18 to removably secure the feeder 16 to the vessel 12.

The extractor assembly 42 preferably broadly includes a mixer or agitator 96 extending from the connection chamber 68, through the cover 94, and through the open top 32a into the interior chamber 32 of the vessel 12. As will be discussed in greater detail below, prior to operation of the feeder assembly 10, the feeder 16 is secured to the top of the vessel 12 via engagement of the cover 94 and the coupler 18, such that that cover 94 extends across the open top 32a of the interior chamber 32 of the vessel 12 and over the rim 26. Then, after the feeder assembly 10 has been transported to a desired location, the entire feeder assembly 10 is inverted such that the base 20 of the vessel 12 is in an uppermost position and any dry material housed in the interior chamber 32 of the vessel 12 and not yet being extracted therefrom is supported on the cover 94 (assuming the open top 34a is coextensive with the rim 26, as depicted in the preferred embodiment).

In greater detail, the cover 94 defines a supply side 98 facing the interior chamber 32 of the vessel 12 and a feed side 100 opposite the supply side 98. Material housed in the interior chamber 32 of the vessel 12 after inversion thereof will rest against the supply side 98 until extracted from the vessel 12.

The cover 94 further preferably in part defines a feed opening 102 in communication with both the interior chamber 32 and the conveyance assembly. More particularly, the feed opening 102 extends entirely through the cover 94 and interconnects the vessel interior chamber 32 and the intake chamber 86 when the feeder 16 is coupled to the vessel 12 via the coupler 18. Thus, when the vessel 12 is inverted as briefly discussed above and discussed in detail below, a portion of the dry matter therein will preferably be transferred from the interior chamber 32 to the intake chamber 86 of the auger 58 via the feed opening 102. Flowability and evenness during this process will preferably be enhanced by the churning or mixing action of the agitator 96.

More particularly, the agitator 96 preferably includes a bearing assembly 104 and a pair of paddles 106 fixed to and extending radially outwardly from the bearing assembly 104. The bearing assembly 104 facilitates rotation of the paddles 106 about the vessel 12 axis (which, in the illustrated embodiment, is perpendicular to the motor axis). Such rotation is driven by the motor (not shown) via engagement of the transmission gear 72 with an agitator gear 108 fixed to the bearing assembly 104 in such a manner that rotation of the agitator gear 108 corresponds with rotation of the paddles 106.

In greater detail still, the bearing assembly 104 preferably includes a supply end 104a and a feed end 104b. In the assembled form of the feeder assembly 10, the supply end 104a is disposed in the open top 32a of the interior chamber 32 of the vessel 12, adjacent the supply side 98 of the cover 94. The paddles 106 preferably extend from the supply end 104a so as to be disposed adjacent the supply side 98 of the cover 94. The feed end 104b of the bearing assembly 104 is disposed in the connecting chamber 68. The agitator gear 108 is secured to the feed end 104b to rotate therewith.

Thus, rotation of the motor output shaft 54 is ultimately transferred both to the paddles 106 and to the auger 58.

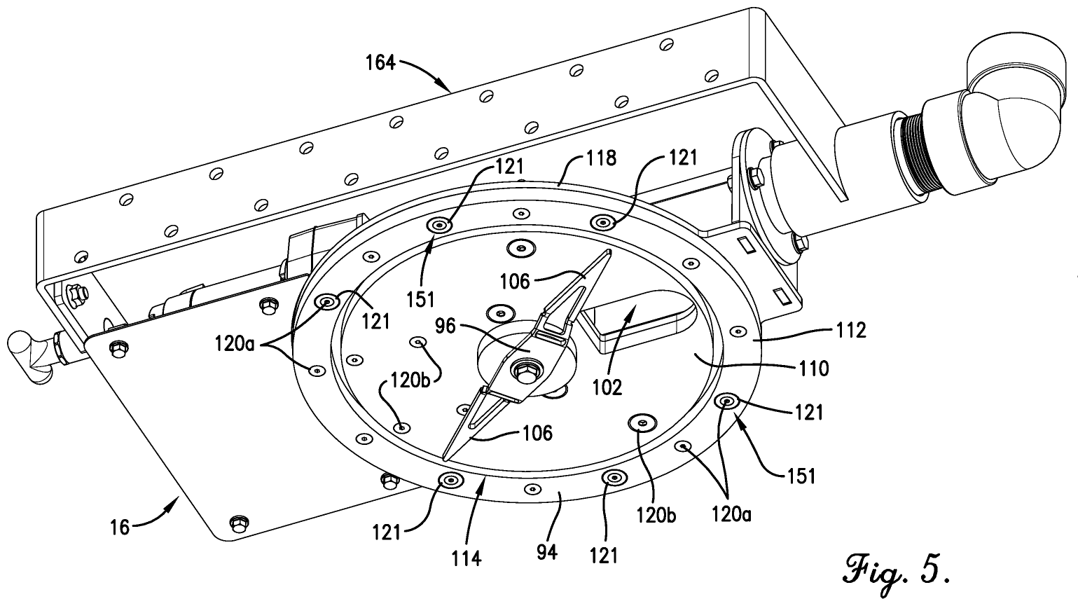

As noted previously, the feeder 16 includes an attachment assembly 48. As also noted previously, the attachment assembly 48 includes the cover 94. More particularly, as best shown in FIG. 5, the cover 94 includes a disc-like inner portion 110 and an outer ring portion 112 encircling the inner portion 110. A circumferentially extending groove or notch 114 is defined in the cover 94 between the inner portion 110 and the outer ring portion 112. The notch 114 receives the rim 26 of the vessel 12 when the cover 94 is disposed on the vessel 12, such that the inner portion 110 extends across the interior chamber 32 of the vessel 12 and the ring portion 112 circumscribes the vessel 12 and, more particularly, the top 32a.

A circumferentially continuous seal (not shown) is preferably disposed in the notch 114 to seal the interface between the vessel 12 and the cover 94 at the notch 114. Such seal might be omitted or alternately configured (e.g., provided instead as a plurality of discrete seals, etc.) without departing from the scope of the present invention, however.

The cover 94 is preferably formed of plastic or another non-magnetic material, although other materials (including metals) may be used without departing from the scope of certain aspects of the present invention.

The attachment assembly 48 additionally preferably includes a backing 118. In a preferred embodiment, the backing 118 at least substantially corresponds to the shape of the cover 94, with the backing 118 being generally disposed in overlying engagement with the cover 94. The backing 118 provides structural support to the cover 94, particularly when the feeder assembly 10 is inverted and dry matter is being supported on the cover 94. The backing 118 also constitutes portions of both the connector housing 66 and the intake portion 84 of the auger housing 60.

The backing 118 preferably cooperates with the cover 94 to define the feed opening 102. That is, the feed opening 102 preferably extends through the entirety of both the cover 94 and the backing 118.

In a preferred embodiment, as illustrated, the cover 94 is secured to the backing 118 at least by means of a plurality of evenly arcuately spaced bolts 120a extending through corresponding openings in the ring portion 112 of the cover 94 and additional bolts 120b extending through the inner portion 110. Other attachment means, including but not limited to adhesives, welds, and/or alternative fastener types such as hooks, latches, and hook-and-loop may alternatively or additionally be used, however.

As will be discussed in greater detail below, certain of the bolts 120a additionally function to secure respective ones of a plurality of coupling elements 121 to the cover 94.

### Coupler

As noted previously, the coupler 18 preferably cooperates with the attachment assembly 48 to secure the feeder 16 to the vessel 12. In a broad sense, and as will be discussed in greater detail below, the coupler 18 is selectively (i.e., removably) secured to the feeder 16 and independently selectively secured to the vessel 12, such that the coupler selectively secures the feeder 16 to the vessel 12.

The coupler 18 is generally in the form of a clamping ring. More particularly, the coupler 18 preferably broadly includes a clamping ring 122 including a pair of arms 124; a pair of handles 126 extending outwardly from the clamping ring 122; and a locking pin 128 for selectively securing the arms 124 relative to one another.

The arms 124 are preferably identical to each other but differently oriented, as illustrated. Each arm 124 preferably extends arcuately between a base 130 and a tip 132 thereof so as to be generally semicircular in form. Each arm 124 preferably includes a main body 134, a hinge tab 136 extending from the main body 134 to the base 130 thereof, and a locking tab 138 extending from the main body to the tip 132 thereof.

Each main body 134 has an axial thickness or depth between opposite upper and lower faces 140 and 142. The hinge tabs 136 preferably have an axial thickness or depth of about half that of the main body 134. Similarly, the locking tabs 138 preferably have an axial thickness or depth of about half that of the main body 134.

Each hinge tab 136 defines an axially extending opening therethrough. Likewise, each locking tab 138 defines an axially extending opening 138a therethrough.

As illustrated, the hinge tabs 136 of each arm 124 preferably overlie one another such that the openings formed in each hinge tab 136 are aligned. A hinge pin or bolt 144 extends through the pair of openings to pivotably secure the arms 124 to one another. That is, the hinge bolt 144 defines a hinge point or axis about which the arms 124 are pivotable.

As will be apparent to those of ordinary skill in the art, pivoting of the arms 124 around the hinge axis facilitates movement of the tips 132 toward or away from one another. The arms 124 are therefore pivotable relative to one another between a maximally open position, in which the arms 124 have pivoted relatively away from each other to a maximum possible extent, and a fully closed or clamping position, in which the arms 124 have pivoted toward each other as much as possible or nearly as much as possible, such that the locking tabs 138 overlie one another.

More particularly, in the illustrated closed or clamping configuration or position, the locking tabs 138 overlie one another such that the openings 138a therethrough are axially aligned. Insertion of the locking pin 128 through the openings 138a is thus possible to prevent any further pivoting of the arms 124 relative to one another. That is, the locking pin 128 selectively locks or secures the coupler 18 and, in particular, the arms 134, in the clamping position.

It is noted that various additional open positions intermediate between the clamping and maximally open positions, are also achievable by the arms 124.

It is also noted that one or more additional or alternative locks, including locks not configured as locking pins, may be provided.

As will be discussed in greater detail below, the hinged and lockable/unlockable nature of the arms 124 of the coupler 18 facilitates opening thereof (via pivoting of the arms 124 away from each other toward or to the fully open position) for placement on the vessel 12, followed by pivoting of the arms 124 toward one other to the fully closed position so as to clamp the vessel 12, followed by insertion of the locking pin 128 to secure the arms 124 in the closed position about the vessel 12. Alternatively stated, the arms 124 cooperatively engage the portable storage vessel 12 when in the clamping position and facilitate placement of the coupler 18 onto the vessel 12 or removal of the coupler 18 therefrom when in the open position.

Preferably, the side 22 of the vessel 12 includes an attachment region 146 adjacent and below the rim 26 so as to be disposed axially between the rim 26 and the projection 36. The attachment region 146 thus preferably constitutes a portion of the aforementioned straight portion 38 of the side 22.

Alternatively characterized, the attachment region 146 preferably circumscribes the open top 32a of the vessel 12.

The arms 124 and the attachment region 146 are preferably complementarily shaped and sized. More particularly, the arms 124 in the closed configuration preferably cooperatively present a radially inner coupler face 148 that extends along a circle having a coupler radius. The attachment region 146 preferably corresponds to the radially inner coupler face 148. More particularly, the attachment region 146 preferably extends along a circle having an attachment region radius. The preferred coupler radius is substantially equal to the attachment region radius, such that the arms 124 (or, more broadly, the coupler 18) securely engage the vessel 12 when the coupler 18 is closed about the attachment region 146. Alternatively stated, the coupler face 148 circumscribes and overlies the attachment region 146 when the coupler 18 is secured to the portable storage vessel 12.

Alternative complemental shapes between the arms and the attachment region (e.g., flared (i.e., not axially straight), non-smooth (e.g., corrugated, etc.), polygonal, etc. are within the ambit of certain aspects of the present invention.

Most preferably, when secured to the vessel 12 as part of the feeder assembly 10, the upper faces 140 of the arms 124 engage the lower surface 30 of the rim 26 and the supply side 98 of the ring portion 112 of the cover 94. The lower faces 142 of the arms 124, in contrast, are preferably spaced axially from the projection 36. It is permissible according to some aspects of the present invention, however, for variations in axial positioning of the coupler relative to features of the vessel to occur.

As noted previously, in a preferred embodiment, the coupler 18 functions to connect the vessel 12 to the feeder 16. As will be discussed in greater detail below, the coupler 18 preferably includes a plurality of coupling elements 150 that, in cooperation with the aforementioned coupling elements 121 of the feeder 16, facilitate such a connection. More particularly, the feeder 16 and the coupler 18 include respective pluralities of complementary coupling elements 121 and 150 configured to selectively securely couple to one another. In a preferred embodiment of the present invention, at least a subset, and most preferably all, of the coupling elements 121 and 150 comprise magnets.

In the illustrated embodiment, for instance, each arm 124 of the coupler 18 includes a trio of arcuately spaced apart coupling elements or magnets 150. When the arms 124 are in the closed configuration, the magnets 150 are preferably evenly arcuately spaced apart and disposed so as to correspond to the previously described coupling elements or magnets 121 fixed relative to the cover 94 by the bolts 120a. That is, the closed clamping ring 122 and the cover 94 can be rotationally manipulated or clocked relative to one another (e.g., through rotation about a shared axis) such that respective ones of the magnets 121 and 150 align axially with each other and may then securely couple to one another. Thus, a magnetic connection between the coupler 18 and the attachment assembly 48 of the feeder 16 may be achieved. (Of course, as will be readily understood by those of ordinary skill in the art, appropriate orientation of the magnets with respect to their polarities is necessary to ensure attractive forces are generated rather than repellant forces.)

It is noted that, although exact or near-exact axial alignment of corresponding ones of the complementary coupling elements 121 and 150 is preferred, coupling may still occur despite at least some degree of mis-alignment. That is, sufficient magnetically attractive forces may exist in some instances between slightly offset pairs of the coupling elements.

It is also reiterated that, as noted above, it is permissible according to some aspects of the present invention for some of the coupling elements to not comprise magnets. For instance, in an alternative embodiment of the present invention, a subset of the coupling elements might simply comprise steel. For example, the aforementioned bolts securing the cover to the backing plate might function as the coupling elements of the feeder, with the magnets of the coupler directly engaging the bolts themselves. Alternatively, the bolts could secure larger magnetically responsive disks to the cover, with such disks comprising steel or similar so as to be responsive to the magnets of the coupler.

An inverted configuration, in which the magnets are provided by the feeder, or a mixed configuration, in which the coupler and the feeder each include both magnets and magnetically responsive elements, is also permissible.

Again, however, provision of magnets for all of the coupling elements rather than just a portion thereof is most preferred, as such an arrangement generates greater connection forces than would be achieved by an alternative embodiment like one of those described above.

As noted previously, the cover 94 is preferably formed of plastic or another non-magnetically responsive material. The clamping ring 122 is likewise preferably formed of plastic or another non-magnetic material, although other materials (including metals) may be used without departing from the scope of certain aspects of the present invention.

The feeder 16 and the coupler 18 preferably define respective pluralities of coupling element-receiving recesses or wells 151 and 152 each receiving a corresponding one of the coupling elements 121 or 150, respectively. More particularly, the cover 94 preferably defines the recesses or wells 151. The clamping ring 122 and, more particularly, the arms 124 thereof, defines the recesses or wells 152.

The coupling elements 121 are preferably secured in the wells 151 by corresponding ones of the bolts 120a. The coupling elements 150 are preferably secured in the wells 152 by corresponding fasteners or bolts 154.

Other means of securement, including but not limited to overmolding, gluing or otherwise adhering, interference fitting, screws, latches, etc. might alternatively or additionally be used without departing from some aspects of the present invention.

Preferably, the coupling elements 121 and 150 are embedded so as to be at least substantially flush with the supply side 98 of the cover 94 and the upper faces 140 of the arms 124, respectively.

Furthermore, although flush, embedded magnets are preferred, it is permissible according to some aspects of the present invention for alternative magnet positioning to be used. Depending on the configuration of responsive surfaces of the feeder unit, for instance, the magnets might overlie the upper surfaces of the arms or be disposed radially outward of the arms.

The preferred non-magnetic nature of the cover 94 and the clamping ring 122 facilitates relatively easy decoupling of the coupler 18 and the cover 94 through twisting or lateral shifting of the cover 94 relative the coupler 18 (or vice versa) and resulting shifting of the magnets 121 into disalignment with the magnets 150. That is, the attractive magnetic force between the cover 94 and the coupler 18 can be broken or significantly decreased using relatively low twisting or shear forces rather than the higher axial forces that would be necessary to separate the components axially. It is permissible according to some aspects of the present invention, however, for the cover and/or the clamping ring to instead be formed in whole or in part of a magnetically responsive material to which the magnets may “adhere.” In such an instance, elimination of one or both sets of discrete complementary coupling elements may be permissible according to some aspects of the present invention, with the cover and/or clamping ring or portions thereof integrally acting as one or more coupling elements. Of course, such embodiments may be disadvantageously heavy and/or expensive, however.

It is particularly noted that the above-described twisting-based disconnection capability is particularly advantageous because jarring of the vessel 12 upon application of high axial forces to separate the vessel 12 from the feeder unit 14 could result in spilling of the material contained therein, release of dust therefrom, etc. Twistable disconnection decreases the likelihood of such outcomes.

It is also noted that the feeder 16 may include additional or alternative means of facilitating magnetic connection thereof with the coupler 18 (i.e., means beyond or instead of the complementary elements 121 of the ring portion 112 of the cover 94). For instance, alternative or additional magnetic connections might be formed between the coupler and elements associated with other portions of the feeder, including the auger housing, the connector housing, and/or other portions of the cover.

The magnets 121 and 150 are preferably of sufficient strength to facilitate an adequate connection force between the coupler 18 and the feeder 16 to avoid shifting or disconnection of the feeder 16 from the vessel 12 during inversion of the vessel 12 (as will be described in greater detail below); during transport, positioning, or repositioning of the feeder assembly 10 to or relative to the target equipment or location; and so on. In a preferred embodiment, the magnets 121 and 150 are high strength rare earth magnets each having a strength of between about one pound (1 lb) and about fifteen pounds (15 lb), more preferably between about five pounds (5 lb) and about ten pounds (10 lb), and most preferably about eight and five tenths pounds (8.5 lb). However, other magnet types (e.g., ferrite) and strengths are permissible according to some aspects of the present invention.

In a preferred embodiment, an elastic strap 158 is provided as a secondary measure for securement of the feeder 16 to the coupler 18. More particularly, the strap 158 includes a band 160 and a pair of hooks 162 at opposite ends of the band 160. The band 160 extends across the connector housing 66, and the hooks 162 are secured to respective ones of the handles 126 of the coupler 18. The strap might be omitted without departing from the scope of the present invention, however, and/or other supplementary securement means might be provided.

As will be readily apparent to those of ordinary skill in the art in view of the above, the coupler 18 is thus selectively or removably secured to the vessel 12 though use of the pivotability of the arms 124 of the clamping ring 122 and is selectively or removably secured to the feeder 16 via coupling of the magnets 121 of the feeder 16 with the magnets 150 of the coupler 18. Thus, it follows that the feeder 16 and the vessel 12 are selectively or removably secured to one another via the coupler 18.

It is noted that various other means for securing the vessel to the feeder fall within the ambit of certain aspects of the present invention. Some such means may include a discrete coupler, as described above, with the coupler being readily separable from both the vessel and the feeder. In such alternative embodiments, the coupler body might be a magnet in its entirety and connect to magnets or magnetically responsive material on the feeder; wing nuts, clamps, latches, or other fasteners might be provided; the coupler might be devoid of magnets but comprise a magnetically responsive material for engaging magnets provided by the feeder; and so on.

In other instances, however, the coupler might be permanently or semi-permanently fixed to (or, alternatively characterized, generally non-removable from) the feeder. In such an instance, the feeder and the coupler nevertheless are preferably cooperatively readily removable from the vessel. It is noted that permanent or semi-permanent fixation of the coupler to a vessel is less preferred, as a key advantage of the present invention is the ease by which various standard vessels may be secured to the same feeder without the need for specialization of the vessels. That is, it is most preferred that, even in alternative embodiments, the coupler be removably coupled to the vessel.

In still other instances, a discrete coupler might be omitted entirely, with the vessel instead connecting directly to the feeder, with any necessary components for securement being integrated into the feeder and/or vessel. Again, however, such an alternative design should still facilitate ready removal of the feeder from the vessel to enable repeated use of the feeder with any of a plurality of vessels.

### Method of Use

As will be apparent from the above, a preferred method of dispensing a material (e.g., a dry particulate or powder material as described above) from the open top portable storage vessel 12 broadly includes the steps of securing the vessel 12 to the feeder 16, such that the feed opening 102 of the feeder 16 is in communication with the interior chamber 32 of the vessel 12 through the open top 32a thereof; collectively inverting the vessel 12 and the feeder 16; and operating the feeder 16 such that material from the vessel 12 is dispensed by the feeder 16.

As will be discussed in greater detail below, the step of securing the vessel 12 to the feeder 16 includes the steps of selectively securing the coupler 18 to the vessel 12 and coupling the coupler 18 to the feeder 16.

The step of securing the coupler 18 to the vessel 12 preferably includes the step of clamping the coupler 18 on the vessel 12, which includes the steps of pivoting the arms 124 of the coupler 18 toward one another and securing the arms 124 snugly about the portable storage vessel. It is preferred that the step of securing the arms 124 snugly about the portable storage vessel 12 includes the step of locking the arms 124 relative to one another.

The steps of clamping the coupler 18 to the portable storage vessel 12 preferably include the step of positioning the arms 124 axially between the circumferentially extending rim 26 and the axially spaced circumferentially extending projection 36 of the vessel 12.

The step of coupling the coupler 18 to the feeder 16 preferably includes the step of magnetically coupling the coupler 18 to the feeder 16.

In a preferred method, the step of collectively inverting the vessel 12 and the feeder 16 includes the step of utilizing at least one of the handles 126 of the coupler 18 to manually lift the portable storage vessel 12 and the feeder 16.

The step of operating the feeder 16 such that material from the vessel 12 is dispensed by the feeder 16 preferably includes the step of rotating the auger 58, which as noted previously is configured to convey material from the feed opening 102.

The method preferably additionally includes the step of twisting the feeder 16 and the coupler 18 relative to each other to remove the feeder 16 from the coupler 18.

In less generalized terms, in a preferred method of use, seed (not shown) to which a dry treatment is to be applied is stored in or ready to be fed or transported through a seed bin, seed hopper, seed feeder, mobile seeder, etc. (also not shown). A dry material (not shown) such as talc or another lubricant (e.g., graphite), micronutrients, inoculants, fungicides, insecticides, biologicals, nematicides, other additives, or combinations thereof is stored in the interior chamber 32 of the vessel 12, which is initially closed by a lid or other covering (not shown).

Most preferably prior to removal of the lid or covering (but permissibly after such removal), the coupler 18 is secured to the attachment region 146 of the vessel 12. More particularly, the arms 124 are pivoted away from each other about the hinge bolt 144 so as to shift into the fully open configuration of the coupler 18, or at least to a sufficiently open configuration such that the tips 132 of the arms 124 are spaced far enough apart to fit the vessel 12 therebetween. The coupler 18 is then shifted toward the vessel 12 (and/or vice versa) such that the vessel 12 passes between the tips 132 and into the central opening of the coupler 18. When the coupler 18 is positioned so as to encircle the attachment region 146 (and thereby circumscribe the soon-to-be open top 32a), in a position axially between the rim 26 and the intermediate projection 36, the arms 124 are pivoted toward one another until locking tabs 138 overlie one another and the openings 138a therethrough are aligned. The inner face 148 of the coupler 18 overlies the attachment region 146, and the arms 124 snugly engage the vessel 12. The locking pin 128 is then installed to prevent re-opening of the coupler 18 and secure the coupler 18 to the vessel 12.

Next, the lid (if present) is removed from the vessel 12, exposing the open top 32a.

The feeder 16 is thereafter placed on top of the coupler 18 and vessel 12, with the outer ring 122 of the feed unit cover 94 overlying the arms 124 of the coupler 18, the rim 26 of the vessel 12 extending into the notch 114, and the inner portion 110 of the cover 94 extending across the open top 32a and enclosing the interior chamber 32 of the vessel 12.

Preferably, the feeder 16 and the coupler 18 (along with the vessel 12) are rotated relative to one another prior to initial placement of the feeder 16 onto the coupler 18 and vessel 12 to ensure at least approximate alignment of the magnets 121 with the magnets 150 and resulting strong engagement or coupling of the coupler 18 relative to the cover 94. Rotational adjustments may be made as necessary after placement, however, to achieve excellent alignment and connection strength.

It is noted that the handles 126 may facilitate efficient rotation of the coupler 18 and the vessel 12 if necessary.

As will be apparent to those of ordinary skill in art, substantial axial force would be required at this stage in the method to dislodge the feeder 16 from the vessel 12. Nevertheless, the strap 158 may then be placed across the connector housing 66 and secured to the handles 126 of the coupler 18 to further secure the feeder 16 to the coupler 18.

The entire feeder assembly 10 may then be manually lifted (e.g., by means of the handles 126) and transported to the desired receptable or target (e.g., a seed bin, seed hopper, seed feeder, mobile seeder, etc.). It is noted that, should frictional forces between the coupler 18 and the attachment region 146 be insufficient to prevent downward slippage of the vessel 12 during transport via the handles 126, contact between the upper faces 140 of the arms and the lower surface 30 of the rim 26 of the vessel 12 would restrict excessive shifting.

It is also noted that it is permissible according to some aspects of the present invention for non-manual or partially non-manual means of lifting and/or transporting the feeder assembly to be used. The manual portability of the feeder assembly 10 is a highly advantageous feature, however, greatly simplifying the method and expanding the scenarios and environments in which the method (and the feeder assembly 10) may be used.

In a preferred embodiment, a mounting assembly 164 is fixed to or near the desired receptacle or target. The mounting assembly 164 preferably includes a mounting bracket 166 and an inversion system 168.

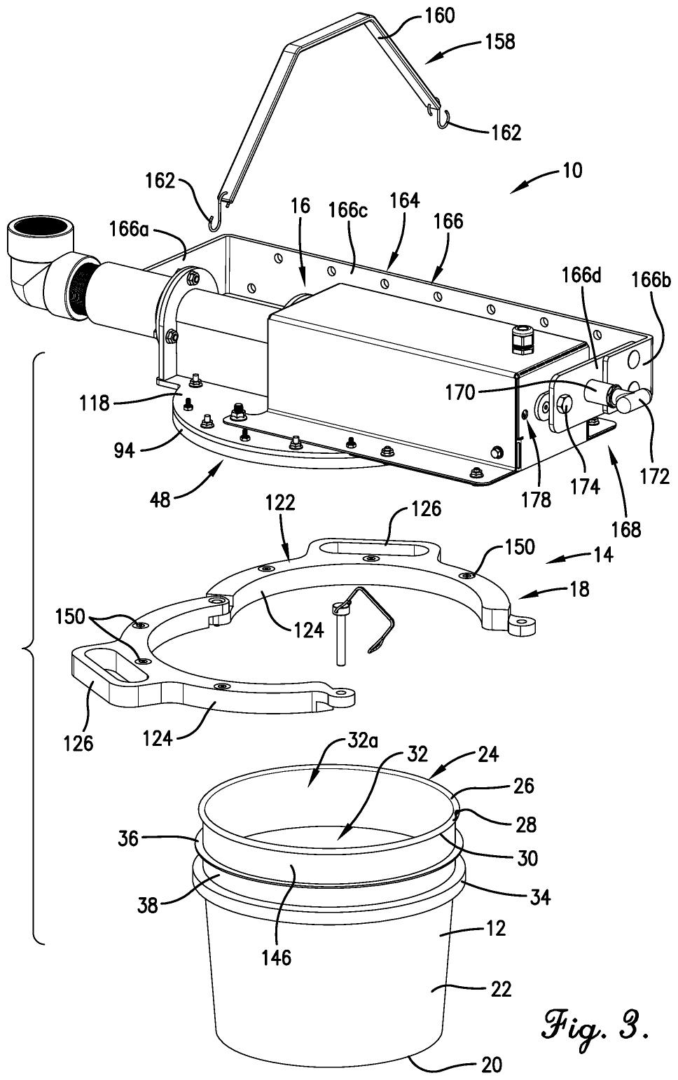

With reference to FIG. 3, the mounting bracket 166 includes arms 166a and 166b spaced apart by a main body 166c. The mounting bracket 166 also includes a support element 166d fixed to the arm 166b.

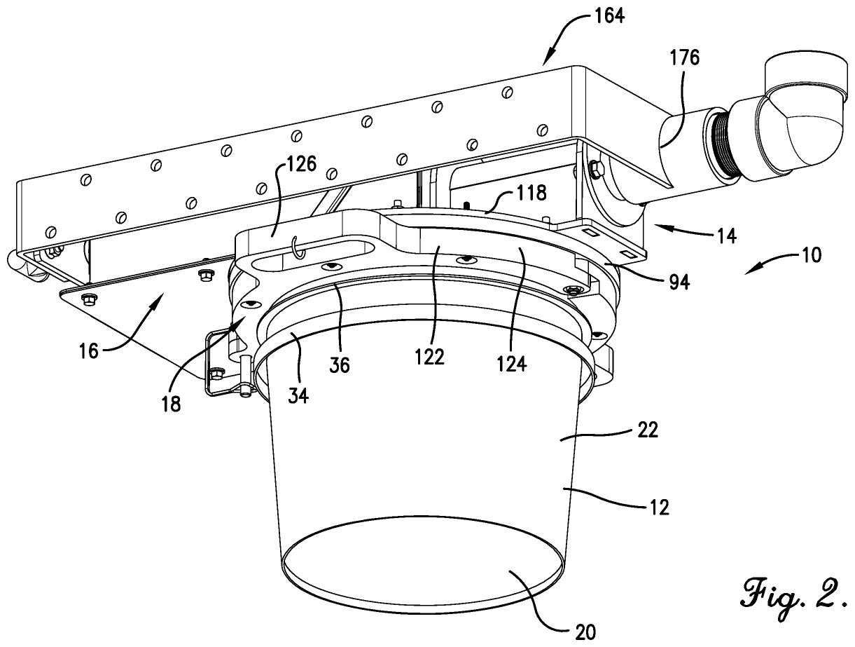

The inversion system 168 includes a spring-loaded pin 170 shiftable in an axial direction via a handle 172, a fixed pivot pin 174, and a rotation guide 176 (see FIG. 2) defined by the bracket arm 166a.

In a preferred methodology, after being manually transported thereto via the handles 126, the feeder assembly 10 is initially secured to the mounting assembly 164 in an upright mounting position. More particularly, the feeder assembly 10 is shifted into a mounting position largely within the bracket 166 and retained therein by the spring-loaded pin 170, which extends through a corresponding opening (not shown) in the connector housing 66; the pivot pin 174, which extends through another opening 177 (FIGS. 6 and 7) in the connector housing 66; and the rotation guide 176, which engages the auger housing 60.

Laterally outward shifting of the pin 170 thereafter enables manual inversion or rotation of the feeder assembly 10 about an axis defined by the pivot pin 174 and the curvature of the rotation guide 176. (Most preferably, this axis is shared by the motor output shaft 54, the transmission shaft 56, and the auger shank 62, as well.) The feeder assembly 10 is preferably rotated until it is fully inverted (i.e., rotated one hundred eighty (180) degrees) such that the outlet opening 92 is disposed in or opens downwardly toward (e.g., is positioned above) the desired receptacle or target.

The handles 126 may aid in facilitating such inversion, although necessary forces may alternatively or additionally be applied to the vessel 12.

The pin 170 thereafter may be released for insertion into a second opening 178 in the connector housing 66, laterally opposite the first opening (not shown), thus locking the feeder assembly 10 in the inverted or dispensation position. The pivot pin 174 and its opening 177 is preferably disposed equidistantly between the first opening and the second opening 178 to facilitate insertion of the pin 170 into either of the first opening (not shown) and second opening 178, dependent on the position of the feeder assembly 10.

It is noted that the combination of the magnets 121 and 150 facilitating secure surface contact between the arms 124 and the outer ring 122 of the cover 94, the rim 26 being received in the notch 114, and the seal (not shown) being disposed in the notch 114 at least substantially eliminates leakage of dry matter from the interior of the vessel 12, even in the inverted configuration.

Upon activation of the motor (not shown) of the conveyance assembly 46, the paddles 106 of the agitator 96 begin to rotate, mixing and separating dry material adjacent the cover 94 (alternatively stated, at the top 32a and at or adjacent the supply side 98 of the cover 94) and assisting in smooth flow of such dry material through the feed opening 102 into the inflow portion 86a of the intake chamber 86 of the auger 58. The auger 58 likewise begins to rotate, with the flighting 64 gradually and evenly shifting the dry material linearly through the auger housing 60. More particularly, the dry material shifts linearly through the channel 82 of the barrel portion 80 and thereafter the output portion 88. That is, the auger 58 provides both metering and transport of the dry material to the outlet opening 92.

The dry material then exits the feeder assembly 10 via the outlet opening 92 into or onto the predetermined target to, for instance, coat or otherwise mix with seeds or particulate therein.

The feeder assembly 10 may then be dismounted from the mounting assembly 164 in a process reverse to that described above and, if desired, be later reattached with a different vessel secured to the feeder 16 via the coupler 18.

It is noted that, although use of a mounting assembly like the mounting assembly 164 as described above is preferred, it is permissible according to some aspects of the present invention for the feeder assembly 10 to be positioned relative to the target in any manner known in the art, including but not limited to other mounting techniques, mechanized lifting and positioning, and manual holding thereof in an appropriate location.

### CONCLUSIONS

The above-described feeder assembly 10 provides numerous advantages. Among other things, for instance, the feeder unit 14 is readily portable, enabling use not only with various dry matter sources but also with various target locations and types.

Furthermore, the feeder unit 14 and can be attached sequentially to (and removed from) multiple vessels in an efficient manner. Alternatively stated, the coupler 18 interchangeably connects storage vessels 12 to the feeder 16.

Still further, as noted previously, the vessels 12 may be of a conventional type, reducing the need for costly and space-taking specialized supply containers (e.g., hoppers, etc.).

Intermediate pouring steps or similar to transfer material from an original storage container to such a specialized container are also eliminated.

Further still, the present feeder assembly 10 facilitates metered dispensation while also encouraging homogeneity of the dispensed product via the agitating or mixing action of the paddles 106. The paddles 106 also aid in facilitating consistent flow of the dry matter into the auger 58.

Numerous variations on the above-described preferred embodiment are also contemplated. For instance, the feeder could be of a different type, including but not limited to a feeder utilizing rotating or non-rotating paddles, a plunger, a vacuum, hydraulics, pneumatics, a pump, etc. Likewise, the material stored initially in the bucket or storage vessel and dispensed therefrom through the feeder could be liquid rather than dry matter, provided necessary adaptations are made to exposed components and to the feeding mechanism. The arms of the coupler could have alternate shapes (e.g., defining a corner) and/or sizes to correspond to the size and shape of typical buckets or storage vessels of the desired material for dispensation, as well. Still further, the inventive coupling means might be utilized to secure non-feeder elements to a given storage container.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A feeder unit for attachment to a portable storage vessel defining an interior chamber, said feeder unit comprising:
a feeder; and
a coupler,
said feeder defining a feed opening in communication with the interior chamber when the feeder is secured to the portable storage vessel by the coupler,
said feeder including a conveyance assembly in communication with the feed opening,
said coupler configured to be selectively securable to the feeder and independently selectively securable to the portable storage vessel, such that the coupler is operable to selectively secure the feeder to the portable storage vessel.

2. The feeder unit of claim 1,
said coupler including a clamping ring,
said clamping ring including a pair of arms pivotable relative to one another between open and clamping positions,
said arms configured to cooperatively engage the portable storage vessel when in the clamping position and facilitate placement of the coupler onto the portable storage vessel or removal of the coupler therefrom when in the open position.

3. The feeder unit of claim 2,
said coupler further including a lock for selectively securing the arms in the clamping position.

4. The feeder unit of claim 1,
said coupler including a handle configured to facilitate lifting of the feeder unit and the portable storage vessel.

5. The feeder unit of claim 1,
said coupler and said feeder including respective pluralities of complementary coupling elements configured to selectively securely couple to one another,
at least a subset of said coupling elements comprising magnets.

6. The feeder unit of claim 5,
each of said coupling elements comprising a magnet.

7. The feeder unit of claim 5,
said coupler and said feeder defining respective pluralities of coupling element-receiving recesses,
each of said coupling element-receiving recesses receiving a corresponding one of said coupling elements.

8. The feeder unit of claim 7,
said coupler including a clamping ring defining the coupling element-receiving recesses of the coupler.

9. The feeder unit of claim 8,
said clamping ring comprising a non-magnetic material.

10. The feeder unit of claim 7,
said feeder including an attachment assembly,
said attachment assembly including a cover at least in part defining the feed opening,
said cover defining the coupling element-receiving recesses of the feeder.

11. The feeder unit of claim 10,
said cover comprising a non-magnetic material.

12. A feeder assembly comprising:
a feeder unit; and
a portable storage vessel defining an interior chamber,
said feeder unit including a feeder and a coupler securing the feeder to the portable storage vessel,
said feeder defining a feed opening in communication with the interior chamber,
said feeder including a conveyance assembly in communication with the feed opening,
said coupler being selectively secured to the feeder and independently selectively secured to the portable storage vessel, such that the coupler selectively secures the feeder to the portable storage vessel.

13. The feeder assembly of claim 12,
said coupler including a clamping ring,
said clamping ring including a pair of arms pivotable relative to one another between open and clamping positions,
said arms cooperatively engaging the portable storage vessel when in the clamping position and facilitating placement of the coupler onto the portable storage vessel or removal of the coupler therefrom when in the open position.

14. The feeder assembly of claim 13,
said coupler further including a lock for selectively securing the arms in the clamping position.

15. The feeder assembly of claim 12,
said coupler including a handle configured to facilitate lifting of the feeder unit and the portable storage vessel.

16. The feeder unit of claim 12,
said coupler presenting a radially inner coupler face,
said portable storage vessel including an attachment region corresponding to said coupler face,
said coupler face circumscribing and overlying said attachment region when the coupler is secured to the portable storage vessel.

17. The feeder assembly of claim 16,
said portable storage vessel including a circumferentially extending rim and a circumferentially extending projection spaced axially from the rim,
said attachment region being disposed axially between said rim and said projection.

18. The feeder assembly of claim 16,
said portable storage vessel presenting an open top,
said attachment region circumscribing the top.

19. The feeder assembly of claim 12,
said coupler and said feeder including respective pluralities of complementary coupling elements configured to selectively securely couple to one another,
at least a subset of said coupling elements comprising magnets.

20. The feeder assembly of claim 19,
each of said coupling elements comprising a magnet.

21. The feeder assembly of claim 19,
said coupler and said feeder defining respective pluralities of coupling element-receiving recesses,
each of said coupling element-receiving recesses receiving a corresponding one of said coupling elements.

22. The feeder assembly of claim 21,
said coupler including a clamping ring defining the coupling element-receiving recesses of the coupler.

23. The feeder assembly of claim 22,
said clamping ring comprising a non-magnetic material.

24. The feeder assembly of claim 21,
said feeder including an attachment assembly,
said attachment assembly including a cover at least in part defining the feed opening,
said cover defining the coupling element-receiving recesses of the feeder.

25. The feeder assembly of claim 24,
said cover comprising a non-magnetic material.

26. The feeder assembly of claim 12,
said portable storage vessel being generally cylindrical in shape,
said interior chamber having a capacity between about 1 gallon and about 10 gallons.

27. A method of dispensing a material from an open top portable storage vessel, said method comprising the steps of:
(a) securing the portable storage vessel to a feeder, such that a feed opening of the feeder is in communication with an interior chamber of the portable storage vessel through the open top;
(b) collectively inverting the portable storage vessel and the feeder; and
(c) operating the feeder such that material from the portable storage vessel is dispensed by the feeder.

28. The method of claim 27,
step (a) including the steps of selectively securing a coupler to the portable storage vessel and coupling the coupler to the feeder.

29. The method of claim 28,
said step of securing the coupler to the portable storage vessel including the step of clamping the coupler on the portable storage vessel.

30. The method of claim 29,
said step of clamping the coupler to the portable storage vessel including the steps of pivoting the arms of the coupler toward one another and securing the arms snugly about the portable storage vessel.

31. The method of claim 30,
said steps of clamping the coupler to the portable storage vessel including the step of positioning the arms axially between a circumferentially extending rim and an axially spaced circumferentially extending projection of the portable storage vessel.

32. The method of claim 30,
said step of securing the arms snugly about the portable storage vessel including the step of locking the arms relative to one another.

33. The method of claim 27,
step (b) including the step of utilizing a handle of the coupler to manually lift the portable storage vessel and the feeder.

34. The method of claim 27,
step (a) including the steps of selectively securing a coupler to the portable storage vessel and coupling the coupler to the feeder,
said step of coupling the coupler to the feeder including the step of magnetically coupling the coupler to the feeder.

35. The method of claim 27,
step (c) including the step of rotating an auger configured to convey material from the feed opening.

36. The method of claim 27, further comprising the step of:
(d) twisting the feeder and the coupler relative to each other to remove the feeder from the coupler.
